(19) United States
(12) Patent Application Publication
(10) Pub. No.: US 2025/0340191 A1
(43) Pub. Date: Nov. 6, 2025

(54) VEHICLE BRAKE SYSTEM

(71) Applicant: Robert Bosch GmbH, Stuttgart (DE)

(72) Inventors: Ryan Kuhlman, Pinckney, MI (US); Eric M. Huff, Plymouth, MI (US); Eric Broman, White Lake, MI (US); Robin Raumer, Plymouth, MI (US); James Timpa, Howell, MI (US); Joseph McAuliffe, Whitmore Lake, MI (US); James Darkangelo, White Lake, MI (US)

(21) Appl. No.: 19/187,618

(22) Filed: Apr. 23, 2025

Related U.S. Application Data
(60) Provisional application No. 63/642,274, filed on May 3, 2024.

(51) Int. Cl. B60T 13/58; B60T 8/171; B60T 8/172; B60T 8/40; B60T 13/14; B60T 13/74

(52) U.S. Cl. CPC B60T 13/58; B60T 8/171; B60T 8/172; B60T 8/4081; B60T 13/142; B60T 13/148; B60T 13/745; B60T 2220/04; B60T 2270/402; B60T 2270/404; B60T 2270/413; B60T 2270/82

(57) ABSTRACT

A vehicle brake system including a brake pedal and a first actuating module. The first acting module includes a master cylinder, a pedal feel simulator, a primary pedal sensor, a first pressure supplier, a first controller, and a first actuating module port. The system includes a second actuating module having a second pressure supplier, a second controller, and a second actuating module port. The vehicle braking system includes a modulation module having first and second ports coupled, respectively, to the first and second actuating module ports, a secondary pedal sensor, a pump, a third controller, and ports coupled to the wheel cylinders. In a redundant back-up mode of operation, the brake request is configured to be met by operation of the pump of the modulation module according to the secondary pedal sensor and the algorithm of the third controller.

### CROSS-REFERENCE TO RELATED APPLICATIONS

This application claims the benefit of priority of co-pending U.S. Provisional Patent Application No. 63/642,274, filed May 3, 2024, the entire contents of which are incorporated by reference herein.

### FIELD

Embodiments, examples, and aspects described herein relate to, among other things, systems and methods for performing hydraulic braking in a vehicle.

### SUMMARY

The present disclosure provides, in one aspect, a vehicle brake system including a brake pedal configured for operation by a driver to receive a braking request and a first actuating module. The first acting module includes a master cylinder coupled to the brake pedal to displace fluid in response to a brake request from the driver, a pedal feel simulator coupled to the master cylinder, the simulator configured to provide tactile feedback to the brake pedal in response to the brake request, a primary pedal sensor, a first decoupled electro-hydraulic pressure supplier operable to displace a fluid, a first controller programmed with an algorithm configured to receive a signal from the primary pedal sensor and to output a signal to the first decoupled electro-hydraulic pressure supplier to control an output thereof to a first braking circuit terminating with a first pair of wheel cylinders, and a first actuating module port. The vehicle braking system includes a second actuating module having a second decoupled electro-hydraulic pressure supplier operable to displace the fluid, a second controller programmed with an algorithm to receive a signal from the first controller and output a signal to the second decoupled electro-hydraulic pressure supplier to control an output thereof to a second braking circuit terminating with a second pair of wheel cylinders, and a second actuating module port. The vehicle braking system includes a modulation module having first and second ports coupled, respectively, to the first and second actuating module ports, a secondary pedal sensor, a pump operable to displace the fluid from the first and second braking circuits, a third controller programmed with an algorithm configured to receive the braking request of the driver via the secondary pedal sensor and to output a signal to the pump to control an output thereof to the first and second brake circuits, and a first pair of ports coupled to the first pair of wheel cylinders and a second pair of ports coupled to the second pair of wheel cylinders. The modulation module is situated between the first and second pairs of wheel cylinders and the first and second decoupled electro-hydraulic pressure suppliers. In a primary brake-by-wire mode of operation, the master cylinder is exclusively in fluid communication with the pedal feel simulator, and the brake request is configured to be met by brake-by-wire operation of the first and second decoupled electro-hydraulic pressure suppliers of the first and second actuating modules according to the primary pedal sensor and the algorithms of the first and second controllers. The vehicle brake system is configured to default to a redundant back-up mode of operation when inoperable in the primary brake-by-wire mode of operation. In the redundant back-up mode of operation, the brake request is configured to be met by operation of the pump of the modulation module according to the secondary pedal sensor and the algorithm of the third controller.

The present disclosure provides, in another aspect, a method of operating a vehicle brake system, the method including operating the vehicle braking system in a primary brake-by-wire mode. The primary brake-by-wire mode includes receiving, with a first controller, a first brake pedal signal from a primary pedal sensor detecting a first braking request. The primary brake-by-wire mode includes setting, with the first controller, a first command to a first fluid actuator, the first fluid actuator operable to displace a fluid in a braking circuit to actuate a wheel cylinder. The primary brake-by-wire mode includes providing the fluid to actuate the wheel cylinder through a modulation module situated between the first fluid actuator and the wheel cylinder. In response to the primary brake-by-wire mode being inoperable, operating the vehicle brake system in a back-up brake-by-wire mode. The back-up brake-by-wire mode includes receiving, with a controller of the modulation module, a second brake pedal signal from a pedal sensor of the modulation module detecting a second braking request. The back-up brake-by-wire mode includes setting, with the controller of the modulation module, a second command to a fluid actuator of the modulation module, the fluid actuator of the modulation module operable to displace a fluid in the braking circuit to actuate the wheel cylinder.

### BRIEF DESCRIPTION OF THE DRAWINGS

FIG. 1 is a schematic diagram of a brake system of a known configuration.

FIG. 2 is a schematic diagram of the brake system of FIG. 1.

FIG. 3 is a schematic diagram of a brake system, according to an embodiment of the present disclosure.

FIG. 4 is a schematic diagram of the brake system of FIG. 3.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include hydraulic or electrical connections or couplings, whether direct or indirect.

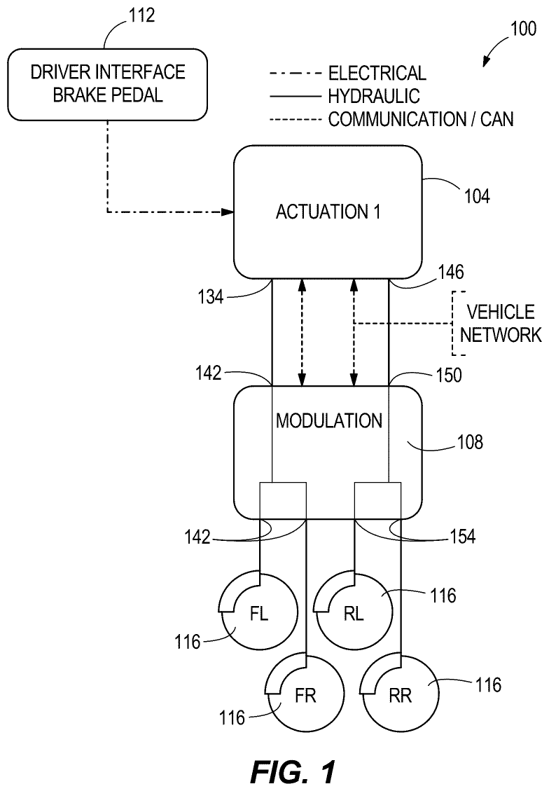

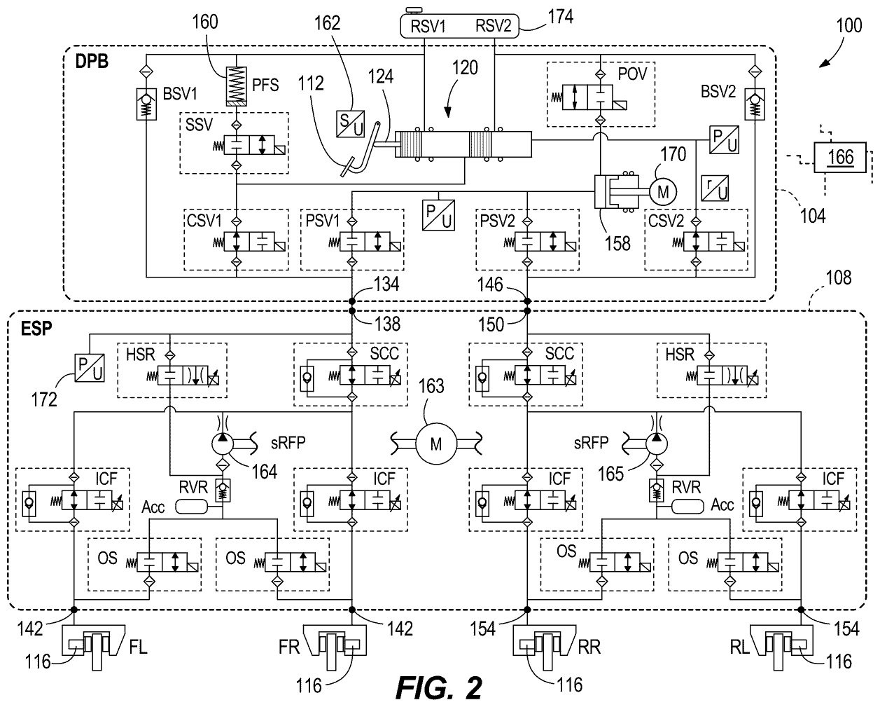

FIGS. 1 and 2 schematically illustrate a vehicle braking system 100 of a known configuration. The vehicle braking system 100 can be used in passenger cars and light trucks (e.g., Class 1 and 2) having a gross vehicle weight rating (GVWR) up to 4536 kg (10000 lbs). Vehicles are classified by GV WR by a government agency, which in the United States is the Federal Highway Administration (FHWA), which groups Classes 1 and 2 as light duty, Class 3 to Class 6 as medium duty, and Classes 7 and 8 as heavy duty. Vehicles in Class 3 to Class 6 have a GVWR between 4536 kg to 11793 kg (10001 to 26000 lbs) and vehicles in Classes 7 and 8 have a GV WR above (26001 lbs). Specifically, vehicles in Class 3 have a GVWR between 4536 kg to 6351 kg (10001 to 14000 lbs), vehicles in Class 4 have a GVWR between 6,351 kg to 7,257 kg (14001 to 16000 lbs), vehicles in Class have a GVWR between 7,528 kg to 8,845 kg (16,001 to 19,500 lbs), and vehicles in Class 6 have a GVWR between 8,846 kg to 11,793 kg (19501 to 26000 lbs). Vehicles with a GVWR of less than 4536 kg (10000 lbs) can use the braking system 100 including a single actuation unit and a single modulation module, as described more below.

The vehicle braking system 100 is a brake-by-wire braking system including an actuating module 104, a modulation module 108 (e.g., a Bosch ESP® module), a driver interface 112 (e.g., a brake pedal), and a plurality of wheel cylinders 116 connected to the modulation module 108. Additional details regarding actuating modules, modulation modules, and/or functions thereof are disclosed in U.S. Pat. Nos. 10,800,389, 12,194,972, and U.S. Patent Application Publication No. 2025/0091556, to Robert Bosch, GmbH the entire contents of which are incorporated herein by reference. Elsewhere in the art, U.S. Pat. No. 12,145,548 also discloses a similar braking system having a pressure supply unit and a motor-pump unit. The entire contents of U.S. Pat. No. 12,145,548 is hereby incorporated by reference. Aspects of the present disclosure can be applied as a modification or improvement to existing brake-by-wire braking systems, including but not limited to those noted above.

As illustrated in FIG. 2, the actuating module 104 is a single unit including a master cylinder 120 in a direct relationship with the brake pedal 112 via an input 124 such that the brake pedal 112 actuates the master cylinder 120 directly through the input 124. The vehicle braking system 100 further includes two separate braking circuits, a first braking circuit and a second braking circuit. The first braking circuit is responsible for actuating wheel cylinders 116 of a front axle and the second braking circuit is response for actuating wheel cylinders 116 of the rear axle. In the illustrated construction, the front axle includes two wheel cylinders 116 and the rear axle includes two wheel cylinders 116. Each braking circuit extends from the actuating module 104, and into and through the modulation module 108 to two of the four wheel cylinders 116. The first braking circuit is operable to route a fluid from a first port 134 of the actuating module 104 through a port 138 of the modulation module 108, and to two of the four wheel cylinders 116 via a first pair of ports 142 of the modulation module 108. The second braking circuit is operable to route a fluid from a second port 146 of the actuating module 104 through a port 150 of the modulation module 108, and to two of the four wheel cylinders 116 via a second pair of ports 154 of the modulation module 108.

The actuating module 104 includes a decoupled electro-hydraulic pressure supplier 158 operable to pressurize a fluid from the actuating module 104 to the wheel cylinders 116 in a brake-by-wire mode of operation. In other words, the decoupled electro-hydraulic pressure supplier 158 is operable to supply fluid volume and/or pressure to the wheel cylinders 116. The master cylinder 120 and decoupled electro-hydraulic pressure supplier 158 are two fluid pressure suppliers. The vehicle braking system 100 includes a third fluid pressure supplier, motor-driven pumps, which will be explained in greater detail below.

As shown in FIG. 2, the actuating module 104 includes a pedal feel simulator 160 that is selectively connected to the master cylinder 120. In some embodiments, the pedal feel simulator 160 relays feedback to the brake pedal 112 proportional to the displacement of the brake pedal 112 by the user. The force-feedback gets firmer the more that the brake pedal 112 is pressed. In the brake-by-wire mode of operation, there is a direct relationship between the stroke input (i.e., travel distance, offset distance) to the brake pedal 112 and the input force required to move the brake pedal 112 by that distance. There is also therefore a predetermined relationship relating the stroke input or travel distance of the brake pedal 112 to the reaction or feedback force provided by the pedal feel simulator 160. The pedal feel simulator 160 provides feedback to the brake pedal 112 according to a fixed characteristic of the pedal feel simulator 160. In some constructions, a distance that the user moves the brake pedal 112 (e.g., the displacement of the input 124) may be measured by a pedal travel sensor 162. Additional details regarding pedal feel simulators incorporated into master cylinders are disclosed in German Patent Application DE 10 2020 202 716 A 1, to Robert Bosch, GmbH the entire contents of which are incorporated herein by reference.

The modulation module 108 includes a second electronically controlled pressure generating unit, a motor-driven pump. The second pressure generating unit includes a motor 163 operable to drive a plurality of pumps 164, 165. The pumps 164, 165 each have an outlet side coupled to pressurize two of the wheel cylinders 116 (e.g., the first pump 164 pressurizes the front wheel cylinders 116 and the second pump 165 pressurizes the rear wheel cylinders 116). In other words, the pump 164 pressurizes the first brake circuit and the pump 165 pressurizes the second brake circuit. Alternatively, the first pump 164 may pressurize the front left wheel cylinder 116 and the rear right wheel cylinder 116 and the second pump 165 may pressurize the front right wheel cylinder 116 and the rear left wheel cylinder 116.

As mentioned above, the modulation module 108 shown includes pairs of ports 142, 154, with each port of the pair being associated with each of the wheel cylinders 116. The modulation module 108 includes a plurality of valves that are selectively opened and closed via feedback from sensors (wheel speed sensors, yaw sensor, etc.) to control aspects of braking such as an anti-lock braking system (ABS), traction control, or an electronic stability program (ESP) that are not possible with the actuating module 104 alone.

The vehicle braking system 100 further includes a controller 166 (FIG. 2). The controller 166 may include a number of individual control units that function separately from one another. For instance, in some constructions, the actuating module 104 may include a control unit and the modulation module 108 may include a control unit that function separately from one another. The controller 166 is programmed to receive signals from various sensors of the vehicle braking system 100. These sensors may include, for example, pressure sensors within the first and/or second circuits and the pedal travel sensor 162 operable to measure an input to the brake pedal 112. The controller 166 is further operable to provide electrical signals to various components of the vehicle braking system 100 to actuate, for example, a motor 170 of the first decoupled electro-hydraulic pressure supplier 158, the motor 163 of the second electronically controlled pressure generating unit, and the various valves. The controller 166 receives a signal from a pressure sensor 172.

The vehicle braking system 100 is operable in multiple modes, including a primary mode, which is a brake-by-wire mode. In the brake-by-wire mode, a user provides an input to the brake pedal 112, displacing the pistons within the master cylinder 120, and thereby displacing fluid from the master cylinder 120. In response to signals from a sensor (e.g., the pressure sensor, the pedal travel sensor 162, etc.), the motor 170 of the decoupled electro-hydraulic pressure supplier 158 is actuated to exert a drive force, thereby displacing and pressurizing brake fluid to provide a braking force at the wheel cylinders 116. A valve is selectively opened to direct fluid from the master cylinder 120 to the pedal feel simulator 160 such that tactile feedback is provided to the brake pedal 112 although the master cylinder 120 does not contribute to braking at the wheel cylinders 116.

The vehicle braking system 100 is operable in an alternate or “boost” mode. The boost mode is utilized when the operator provides an input to the brake pedal 112 and the first decoupled electro-hydraulic pressure supplier 158 provides a volume and/or pressure of fluid to the wheel cylinders 116 that is deemed insufficient by the controller 166 in relation to the brake request at the brake pedal 112. In the boost mode, the master cylinder 120 remains disconnected from the wheel cylinders 116 and the motor 163 of the modulation module 108 runs the pumps 164, 165 to draw fluid from a reservoir 174 to provide additional volume and/or pressure to the wheel cylinders 116 in order to supplement the fluid output from the pressure supplier 158. The controller 166 controls the modulation module 108 based on the signals from the pedal travel sensor 162. Additionally, the controller 166 controls the modulation module 108 based on signals from the pressure sensor 172. In other words, the controller 166 controls the modulation module 108 based on the signals from the pedal travel sensor 162 and/or the pressure sensor 172.

In other modes, the modulation module 108 may act on its own to generate braking at the wheel cylinders 116 autonomously, without any operator input to the brake pedal 112 (e.g., collision avoidance, adaptive cruise control, etc.).

In another alternative or “push-through” mode of operation, the master cylinder 120 is fluidly coupled to the wheel cylinders 116 where the pressure applied at the master cylinder 120 by the user at the brake pedal 112 is transferred to the wheel cylinders 116. The push-through mode of operation serves to provide redundancy in the instance that the actuating module 104 is inoperable to perform braking in the primary or brake-by-wire mode (i.e., due to a mechanical or electrical fault).

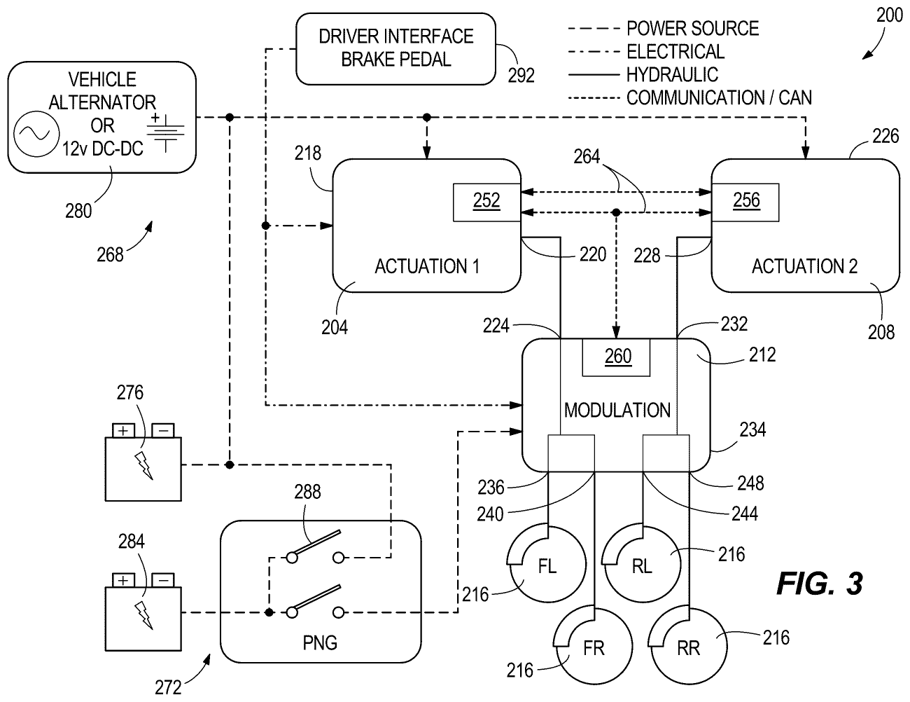

FIG. 3 illustrates a vehicle braking system 200 for use with vehicles with a GVWR above 4536 kg (10000 lbs), and in some constructions over 6350 kg (14000 lbs), above 7257 kg (16000 lbs), or above 8845 kg (19500 lbs). As such, the vehicle braking system can be used in medium duty and heavy vehicles (i.e., Class 3 to Class 8). Above a GVWR 4536 kg (10000 lbs), the fluid volume and/or pressure requirements of the braking requirements can exceed the capabilities of the commercially available actuation and modulation modules 104, 108 of the vehicle braking system 100. In particular, heavier vehicles capable of carrying heavier loads include wheel cylinders that consume substantially more fluid volume than the actuating module 104 can provide in a push-through redundancy scenario. Although one could re-engineer the actuating module 104 of FIGS. 1 and 2 with some form of brake assist, particularly to meet the demands for these heavier vehicles, large capital costs for development may be difficult to allocate when the total market for these vehicles is a small percentage of the more common passenger cars and light vehicles. Additionally, it is worth noting that the vehicle braking system 200 is also compatible with vehicles with a GVWR below 4536 kg (10000 lbs).

FIG. 3 schematically illustrates a vehicle braking system 200 for vehicles with a GVWR above 4536 kg (10001 lbs), according to an embodiment of the present disclosure. Stated in another way, the vehicle braking system 200 can be used with medium duty vehicles (i.e., vehicles in Class 3 to Class 6) and with heavy duty vehicles (i.e., vehicles in Class 7 to Class 8). In other words, the vehicle braking system 200 can be used for vehicles in Class 3, 4, 5, 6, 7, and/or 8. The vehicle braking system 200 is a brake-by-wire braking system including a first actuating module 204, a second actuating module 208, a modulation module 212 (e.g., a Bosch ESP® module), and a plurality of wheel cylinders 216 (as shown, the vehicle braking system 200 includes four wheel cylinders 216) connected to the modulation module 212. The first actuating module 204 supplies fluid pressure to the wheel cylinders 216 of the front axle and the second actuating module 208 supplies fluid pressure to the wheel cylinders 216 of the rear axle. In some embodiments, the first actuating module 204 is a single unit including a housing 218 having a first port 220 for connection to, for example, a first port 224 of the modulation module 212. In some embodiments, the second actuating module 208 is a single unit including a housing 226 having a second port 228 for connection to, for example, a second port 232 of the modulation module 212. In some embodiments, the modulation module 212 is a single unit including a housing 234 having the first and the second ports 224, 232 and the ports 236, 240, 244, and 248. The vehicle braking system 200 includes two separate and independent braking circuits, a first braking circuit and a second braking circuit. The first braking circuit extends from the first actuating module 204 and into and through the modulation module 212 to two of the four wheel cylinders 216. Stated in another way, the first braking circuit is responsible for actuation of the wheel cylinders 216 of a front axle of the vehicle. Specifically, the modulation module 212 includes the first port 236 and the second port 240 (i.e., a first port pair) that each couple to a respective wheel cylinder 216. The second braking circuit extends from the second actuating module 208 and into and through the modulation module 212 to two of the four wheel cylinders 216. Stated in another way, the second braking circuit is responsible for actuation of the wheel cylinders 216 of a rear axle of the vehicle. Specifically, the modulation module 212 includes the third port 244 and the fourth port 248 (i.e., a second port pair) that each couple to a respective wheel cylinder 216. The modulation module 212 is situated fluidly in series between each one of the first and the second actuating modules 204, 208 and the associated wheel cylinders 216.

The first actuating module 204 includes a first controller 252 programmed with an algorithm configured to receive a brake request and to output a signal to control an output to the first braking circuit to satisfy the brake request for the associated wheel cylinders 216. The second actuating module 208 includes a second controller 256 programmed with an algorithm configured to receive a signal from the first controller 252 and output a signal to control an output to the second braking circuit to satisfy the brake request for the associated wheel cylinders 216. The modulation module 212 includes a third controller 260 (e.g., a back-up brake-by-wire controller) programmed with an algorithm configured to receive a brake request of the driver (among other inputs, such as wheel speed, yaw, and or steering angle) and to output a signal to modify, including increasing or decreasing, the fluid pressure and/or volume to any one or more of the wheel cylinders 216 of the first and the second braking circuits as compared to the fluid pressure and/or volume output from the actuating modules 204, 208 to the respective ports 224, 232 of the modulation module 212. As such, the modulation module 212 can selectively reduce or boost brake force at individual wheels of the vehicle having the braking system 200. As noted previously, the modulation module 212 provides these and other capabilities that are not possible with the actuating modules 204, 208 alone.

The first actuating module 204, the second actuating module 208, and the modulation module 212 are communicatively coupled with each other via a high-speed communication connection 264 (e.g., CAN). The high-speed communication connection 264 enables components, such that the controllers 252, 256, 260, of the first actuating module 204, second actuating module 208, and the modulation module 212 to communicate with each other.

Additionally, the first and the second actuating modules 204, 208 are provided with a first power supply 268 and the modulation module 212 is provided with a second power supply 272. The second power supply 272 provides power to the modulation module 212 regardless of the first power supply 268 to provide redundancy in the instance that the first power supply 268 fails. In other words, the second power supply 272 provides a redundant 12-volt power supply to the modulation module 212 such that the second power supply 272 independently supplies power to the modulation module 212. In some constructions, the first power supply 268 comprises a battery 276 and an alternator 280 of the vehicle to supply power to the first and the second actuating modules 204, 208. In some constructions, the second power supply 272 includes a battery 284 that is connected to the first power supply 268 via a switch 288. The switch 288 enables the battery 284 of the second power supply 272 to be recharged by the alternator 280 or the battery 276 of the first power supply 268.

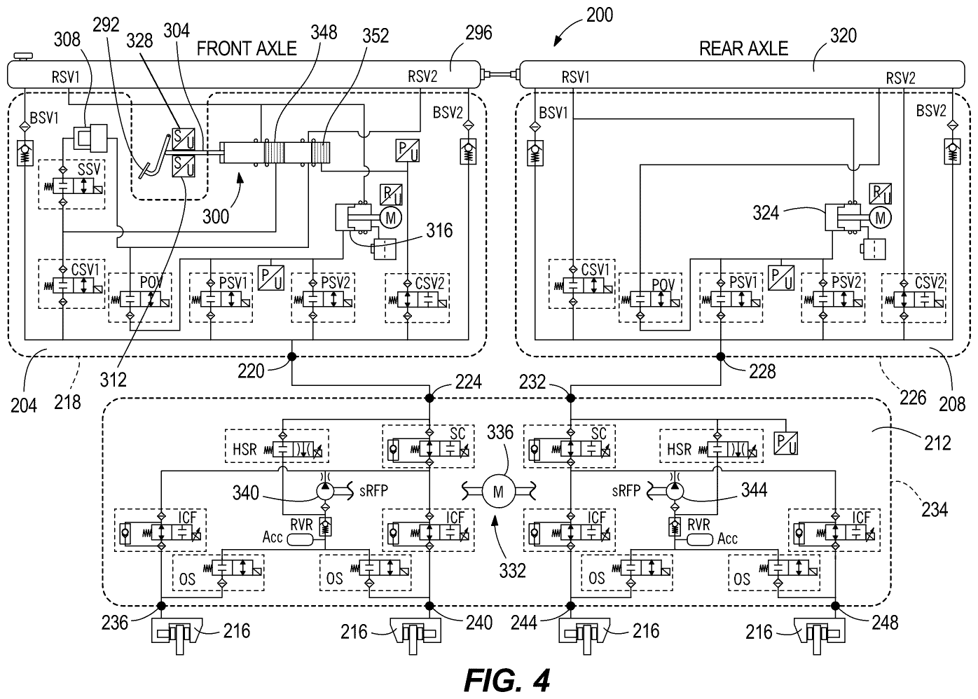

As illustrated in FIG. 4, the vehicle braking system 200 includes a driver interface 292 (i.e., a brake pedal) configured for operation by a driver to receive a braking request. The first actuating module 204 is coupled to a first reservoir 296 and is operable to supply fluid volume and/or pressure to the first braking circuit. The first actuating module 204 includes a master cylinder 300 in a direct relationship with the brake pedal 292 via an input 304 (e.g., rod). In other words, contrary to the schematic illustration, the brake pedal 292 is external to the housing 218 of the first actuating module 204 and the input 304 is received directly by the first actuating module 204. The brake pedal 292 actuates the master cylinder 300 directly through the input 304. The first actuating module 204 includes a pedal feel simulator 308 that is selectively coupled to the master cylinder 300. The pedal feel simulator 308 is configured to provide tactile feedback to the driver at the brake pedal 292 proportional to the displacement of the brake pedal 292 by the user. The first actuating module 204 includes a primary pedal sensor 312 configured to detect a brake input of the brake pedal 292 (representing the braking request) and output a signal to a first controller 252. In some constructions, the primary pedal sensor 312 is a force sensor. In some constructions, the primary pedal sensor 312 is a displacement sensor. The primary pedal sensor 312 is integrated within the housing 218 of the first actuating module 204. In some constructions, the primary pedal sensor 312 includes a magnet needle coupled to the input rod 304 and a sensing circuit to detect the position of the magnet needle. The first controller 252 is programmed with an algorithm configured to receive the signal from the primary pedal sensor 312 and to output a signal to a first decoupled electro-hydraulic pressure supplier 316 (e.g., plunger, linear actuator, etc.) to control an output thereof to the first braking circuit. The first decoupled electro-hydraulic pressure supplier 316 is operable to pressurize and depressurize the fluid in the first brake circuit. The first decoupled electro-hydraulic pressure supplier 316 may be referenced as a first fluid actuator.

In some constructions, the second actuating module 208 is a simplified or “de-contented” version of the first actuating module 204. The second actuating module 208 includes a second reservoir 320 operable to supply fluid to the second braking circuit. The second actuating module 208 includes a second decoupled electro-hydraulic pressure supplier 324 (e.g., plunger, linear actuator, etc.). The second decoupled electro-hydraulic pressure supplier 324 is operable to pressurize and depressurize the fluid in the second brake circuit. The second decoupled electro-hydraulic pressure supplier 324 may be referenced as a second fluid actuator. The second actuating module 208 includes a second controller 256 programmed with an algorithm configured to receive a signal from the first controller 252 and output a signal to the second decoupled electro-hydraulic pressure supplier 324 to control an output thereof to the second braking circuit. In some constructions, the second controller 256 relies on the first controller 252 to supply brake requests because the second controller 256 does not receive signals from the primary pedal sensor 312. In other words, the first and second actuating modules 204, 208 operate as master and slave units. In some constructions, the first controller 252 merely transmits the signal from the primary pedal sensor 312 to the second controller 256. In some constructions, the first controller 252 sends a calculated signal to the second controller 256 in response to receiving the signal from the primary pedal sensor 312, rather than just transmitting the signal from the primary pedal sensor 312.

The modulation module 212 includes a secondary pedal sensor 328. In the illustrated construction, the secondary pedal sensor 328 is configured to detect the brake input of the brake pedal 292 (representing the braking request) and output a signal to the third controller 260. A signal from the secondary pedal sensor 328 to the third controller 260 may be sent or utilized exclusively when failing over to a redundant back-up mode of the braking system 200. The primary pedal sensor 312 and the secondary pedal sensor 328 each detects the braking request independently from one another. Although the secondary pedal sensor 328 functions as a part of the modulation module 212, the secondary pedal sensor 328 is located external to the housing 234 of the modulation module 212. In some constructions, the secondary pedal sensor 328 is physically coupled to a brake pedal box, which receives the brake pedal 292. The brake pedal 292 is external to the housing 218 of the first actuating module 204. Accordingly, the brake pedal box and the secondary pedal sensor 328 are external to the first actuating module 204. In the illustrated construction, the secondary pedal sensor 328 includes an arm that is connected to the brake pedal 292. The secondary pedal sensor 328 is configured to detect the travel of the brake pedal 292 (representing the braking request). In some constructions, the secondary pedal sensor 328 detects the angular displacement of the arm connected to the brake pedal 292. In some constructions, the secondary pedal sensor 328 is a force sensor that detects force acting on the brake pedal 292. In some embodiments, the secondary pedal sensor 328 is coupled to the brake pedal 292 and detects the force of the driver (representing the braking request). In some constructions, the secondary pedal sensor 328 is coupled to the input 304 and detects the force of the driver (representing the braking request). It is worth noting that the force sensor and displacement sensor discussed with respect to the secondary pedal sensor 328 can also be used with the primary pedal sensor 312. In some constructions, the secondary pedal sensor 328 is coupled to the housing 218 of the first actuating module 204 as an add-on or modification to the first actuating module 204. In other words, the first actuating module 204 can be constructed from and interchangeable with the actuating module 104 of the brake system of FIGS. 1 and 2, which has one integrated pedal travel sensor 162 therein. The secondary pedal sensor 328 can be native to a control system of the modulation module 212 (via the third controller 260 and the second power supply 272) despite being mounted on the first actuating module 204. The secondary pedal sensor 328 may be configured to provide an output signal exclusively to the third controller 260 (e.g., not in communication with the first controller 252 of the first actuating module 204). As discussed further below, the third controller 260 is programmed with a redundant algorithm configured to receive the braking request of the driver via the secondary pedal sensor 328. The modulation module 212 includes an electronically-controlled pressure generating unit 332 (e.g., a fluid actuator) to contribute fluid and/or volume to the first and the second braking circuits. The pressure generating unit 332 includes a motor 336 operable to drive a plurality of pumps 340, 344. Each pump 340, 344 has an outlet side coupled to pressurize two of the wheel cylinders 216. In other words, the first pump 340 pressurizes the front wheel cylinders 216 and the second pump 344 pressurizes the rear wheel cylinders 216. Stated another way, the pump 340 is configured to pressurize the first brake circuit and the pump 344 is configured to pressurize the second brake circuit.

The braking system 200 is operable in at least three modes: a primary brake-by-wire mode, an alternate or “boost” mode of operation in which the modulation module 212 is used as boost in tandem with the first and second actuating modules 204, 208, and a redundant, brake-by-wire back-up mode of operation in which the modulation module 212 acts as a fully redundant actuating module (e.g., braking when the first actuating module 204 is inoperable). In the primary brake-by-wire mode of operation, the first and the second actuating modules 204, 208 are capable of supplying sufficient fluid volume and pressure to activate the wheel cylinders 216 to meet the brake request without support from the modulation module 212. The modulation module 212 remains active in standby to take intervention as-needed, similar to the modulation module 108 of FIGS. 1 and 2 (e.g., ABS, traction control, stability control). In the boost mode of operation, the modulation module 212 contributes volume and/or pressure of fluid to the wheel cylinders 216 in addition to the volume and/or pressure of fluid supplied by the first and the second actuating modules 204, 208 to meet the brake request. In the brake-by-wire back-up mode of operation, the modulation module 212 is capable of supplying sufficient fluid volume and/or pressure to activate the wheel cylinders 216 to meet the brake request, without support from the first and the second actuating modules 204, 208.

Unlike the vehicle braking system 100 of FIGS. 1 and 2, the braking system 200 does not rely on a push-through mode of operation where the pressure applied by the user at the brake pedal 292 is transferred to the wheel cylinders 216. This is because the braking system 200, which is designed for vehicles with a GVWR above 4536 kg (10001 lbs), includes the master cylinder 300 being undersized (e.g., sized for vehicles with a GVWR below 4536 kg) and therefore incapable of supplying sufficient fluid volume and/or pressure to activate the wheel cylinders 216 to meet minimum braking performance. For instance, for a master cylinder to supply enough fluid volume for redundant operation via push-through in vehicles with a GVWR above 4536 kg (10001 lbs), the master cylinder may displace a total fluid volume between 80 cc to 120 cc. For reference, the master cylinder 300 in the braking system 200 may have a total fluid volume less than 60 cc. The master cylinder 300 can have a total fluid volume of 5 cc to 50 cc. The master cylinder 300 can have a total fluid volume of 40 cc or less, 30 cc or less, or 20 cc or less. Specifically, in some constructions, the master cylinder 300 has 15 cc of total fluid volume. To compensate for a master cylinder incapable of a push-through mode of operation, the braking system 200 utilizes the modulation module 212 to provide wholly redundant operation via the modulation module 212 taking over for the first and the second actuating modules 204, 208, which will be discussed further below.

In the primary brake-by-wire mode of operation, the brake pedal 292 is engaged by the driver such that the primary pedal sensor 312 detects the brake input of the brake pedal 292. A first chamber 348 of the master cylinder 300 is switched by a valve into communication with the pedal feel simulator 308 and a second chamber 352 of the master cylinder 300 remains disconnected from the wheel cylinders 216. As the driver displaces the brake pedal 292 to establish the brake request, the primary pedal sensor 312 detects the brake input of the brake pedal 292 and outputs a signal to the first controller 252. The algorithm of the first controller 252 receives the signal from the primary pedal sensor 312 and outputs a signal to the first decoupled electro-hydraulic pressure supplier 316 to supply fluid to activate the wheel cylinders 216 of the first braking circuit to meet the brake request in the first braking circuit. Additionally, the algorithm of the first controller 252 outputs signals to the controllers of the second actuating module 208 and the modulation module 212.

Specifically, the algorithm of the first controller 252 outputs a signal to an algorithm of the second controller 256 in response to the brake response detected by the primary pedal sensor 312. After receiving the signal, the algorithm of the second controller 256 outputs the signal to the second decoupled electro-hydraulic pressure supplier 324 to supply fluid to activate the wheel cylinders 216 of the second braking circuit to meet the brake request in the second braking circuit. In the primary brake-by-wire mode of operation, the brake request of the driver is met by the first actuating module 204 and the second actuating module 208. In other words, the modulation module 212 does not contribute to the brake request.

In some constructions, the algorithm of the first controller 252 outputs a signal to the third controller 260. In response to the signal, the algorithm of the third controller 260 does not contribute fluid pressure and/or volume to the first or the second braking circuit. In other words, although the secondary pedal sensor 328 detects the brake input of the brake pedal 292, the modulation module 212 does not contribute to the braking response because the first and the second actuating modules 204, 208 sufficiently supply fluid volume and pressure to activate the wheel cylinders 216 to meet the brake request.

In the boost mode of operation, the first and the second decoupled electro-hydraulic pressure supplier 316, 324 operate normally but do not generate sufficient fluid volume and/or pressure to the wheel cylinders 216. In the boost mode, the master cylinder 300 remains disconnected from the wheel cylinders 216. In the boost mode, the third controller 260 receives the braking request of the driver via the first controller 252 and outputs a signal to the pressure generating unit 332 to control an output thereof to the first and the second braking circuits. Stated in another way, the motor 336 of the pressure generating unit 332 runs the pumps 340, 344 to draw fluid from the reservoirs 296, 320 to provide additional volume and/or pressure to the wheel cylinders 216 in addition to the fluid volume and/or pressure supplied by the first and second decoupled electro-hydraulic pressure suppliers 316, 324 of the first and the second actuating modules 204, 208. In other words, the pressure generating unit 332 operates in response to signals from the first the first actuating module 204.

In other modes, separate from the redundant back-up, the modulation module 212 may act on its own to generate braking at the wheel cylinders 216 autonomously, without any operator input to the brake pedal 292 (e.g., collision avoidance, adaptive cruise control, etc.).

In the redundant back-up mode of operation, the brake pedal 292 is engaged by the driver such that the primary pedal sensor 312 and the secondary pedal sensor 328 detect the brake input of brake pedal 292. The algorithms of the first controller 252 and third controller 260 communicate with one another, and the algorithm of the third controller 260 identifies that the first and the second actuating modules 204, 208 are inoperable and cannot contribute to the brake response. Alternatively, the algorithm of the third controller 260 may identify a lack of communication with the first controller 252. In response to identification that the first and the second actuating modules 204, 208 and/or the first controller 252 is inoperable, the third controller 260 takes over as the main controller for the brake system 200 and the modulation module 212 takes over as the actuating module for operation. For example, the valves of the first and second actuating modules 204, 208 may assume their at-rest states, whereby the first actuating module 204 mimics a push-through configuration where the master cylinder 300 is connected to the modulation module 212 (and cut off from the pedal feel simulator), and the first decoupled electro-hydraulic pressure supplier 316 is cut-off from the circuit. However, like the primary brake-by-wire mode, the redundant back-up mode is also a brake-by-wire mode in which the driver's braking request is determined by sensing the driver's input and the driver's braking request can be predominantly met by an electronic device separate from the master cylinder 300. The algorithm of the third controller 260 outputs a signal to the motor 336 such that the plurality of pumps 340, 344, supply fluid pressure and volume to the wheel cylinders 216 in the first braking circuit and the wheel cylinders 216 in the second braking circuit. In the redundant back-up mode, the modulation module 212 is operable to pull fluid from the reservoirs 296, 320 through the first and second actuating modules 204, 208. In doing so, the modulation module 212 may also pull fluid from the master cylinder 300, which invalidates master cylinder pressure sensing that might otherwise be used during active use of the modulation module 212. Conventional modulation modules would be inoperable in the redundant back-up mode of the braking system 200 because conventional modulation modules rely on master cylinder pressure sensing within the first actuating module 204. Since the modulation module 212 pumps a large volume of fluid from the first actuating module 204, the pressure within the first actuating module 204 would drop and provide an inaccurate representation of the brake request. As such, the secondary pedal sensor 328 functions to accurately detect the brake input of the brake pedal 292 and output a signal regardless of fluid being pulled from the first and the second actuation modules, enabling full functionality of the modulation module 212 in the redundant back-up mode. Operation in the redundant back-up mode does not rely on electrical power or signals used to operate the primary brake-by-wire mode. The braking system 200 is configured to normally operate in the primary mode and default automatically to the redundant back-up mode of operation when inoperable in the primary mode.

Various features of the disclosure are set forth in the following claims.

What is claimed is:

1. A vehicle brake system comprising:
a brake pedal configured for operation by a driver to receive a braking request;
a first actuating module including
a master cylinder coupled to the brake pedal to displace fluid in response to a brake request from the driver,
a pedal feel simulator coupled to the master cylinder and configured to provide tactile feedback to the brake pedal in response to the brake request,
a primary pedal sensor,
a first decoupled electro-hydraulic pressure supplier operable to displace a fluid,
a first controller programmed with an algorithm configured to receive a signal from the primary pedal sensor and to output a signal to the first decoupled electro-hydraulic pressure supplier to control an output thereof to a first braking circuit terminating with a first pair of wheel cylinders, and
a first actuating module port;
a second actuating module including
a second decoupled electro-hydraulic pressure supplier operable to displace the fluid,
a second controller programmed with an algorithm to receive a signal from the first controller and output a signal to the second decoupled electro-hydraulic pressure supplier to control an output thereof to a second braking circuit terminating with a second pair of wheel cylinders, and
a second actuating module port; and
a modulation module including
first and second ports coupled, respectively, to the first and second actuating module ports,
a secondary pedal sensor,
a pump operable to displace the fluid from the first and second braking circuits,
a third controller programmed with an algorithm configured to receive the braking request of the driver via the secondary pedal sensor and to output a signal to the pump to control an output thereof to the first and the second brake circuit, and
a first pair of ports coupled to the first pair of wheel cylinders and a second pair of ports coupled to the second pair of wheel cylinders,
wherein the modulation module is situated between the first and second pairs of wheel cylinders and the first and second decoupled electro-hydraulic pressure suppliers,
wherein, in a primary brake-by-wire mode of operation, the master cylinder is exclusively in fluid communication with the pedal feel simulator, and the brake request is configured to be met by brake-by-wire operation of the first and second decoupled electro-hydraulic pressure suppliers of the first and second actuating modules according to the primary pedal sensor and the algorithms of the first and second controllers,
wherein the vehicle brake system is configured to default to a redundant back-up mode of operation when inoperable in the primary brake-by-wire mode of operation, and
wherein, in the redundant back-up mode of operation, the brake request is configured to be met by operation of the pump of the modulation module according to the secondary pedal sensor and the algorithm of the third controller.

2. The vehicle brake system of claim 1, further comprising a first power supply configured to power the first actuating module and a second power supply configured to power the modulation module.

3. The vehicle brake system of claim 2, wherein the first power supply is configured to power the second decoupled electro-hydraulic pressure supplier.

4. The vehicle brake system of claim 1, wherein the second actuating module has no master cylinder and operates as a slave module to the first actuating module in the primary brake-by-wire mode.

5. The vehicle brake system of claim 1, wherein the first actuating module includes a housing, wherein the modulation module includes a housing separate from the housing of the first actuating module, and wherein the secondary pedal sensor is mounted on the brake pedal.

6. A vehicle comprising the vehicle brake system of claim 1, wherein the master cylinder has a total fluid volume less than 60 cc and the vehicle has a gross vehicle weight rating above 4536 kg.

7. The vehicle of claim 6, wherein the master cylinder has a total fluid volume of 30 cc or less.

8. The vehicle of claim 7, wherein the vehicle has a gross vehicle weight rating above 6350 kg.

9. A method of operating a vehicle brake system, the method comprising:
operating the vehicle brake system in a primary brake-by-wire mode, the primary brake-by-wire mode including
receiving, with a first controller, a first brake pedal signal from a primary pedal sensor detecting a first braking request,
setting, with the first controller, a first command to a first fluid actuator, the first fluid actuator operable to displace a fluid in a braking circuit to actuate a wheel cylinder coupled to the braking circuit; and
providing the fluid to actuate the wheel cylinder through a modulation module situated between the first fluid actuator and the wheel cylinder, and
in response to the primary brake-by-wire mode being inoperable, operating the vehicle brake system in a back-up brake-by-wire mode, the back-up brake-by-wire mode including
receiving, with a controller of the modulation module, a second brake pedal signal from a pedal sensor of the modulation module detecting a second braking request, and
setting, with the controller of the modulation module, a second command to a fluid actuator of the modulation module, the fluid actuator of the modulation module operable to displace a fluid in the braking circuit to actuate the wheel cylinder.

10. The method of claim 9, further comprising powering, with a first power supply, the first controller, the primary pedal sensor, and the first fluid actuator.

11. The method of claim 9, further comprising powering, with a second power supply, the controller of the modulation module, the pedal sensor of the modulation module, and the fluid actuator of the modulation module.

12. The method of claim 9, wherein operating the primary brake-by-wire mode further includes
receiving, with a second controller, a signal from the first controller and
setting, with the second controller, a command to a second fluid actuator, the second fluid actuator operable to displace a fluid in the braking circuit to actuate the wheel cylinder.

13. The method of claim 9, wherein receiving the second brake pedal signal from the pedal sensor of the modulation module is exclusive to the controller of the modulation module.

14. The method of claim 9, wherein detecting the second braking request with the pedal sensor of the modulation module is independent from the primary pedal sensor.

15. The method of claim 9, wherein detecting the first braking request with the primary pedal sensor further comprises detecting a position of an input rod coupled to the brake pedal.
